(19) United States
(12) Patent Application Publication
(10) Pub. No.: US 2020/0096968 A1
(43) Pub. Date: Mar. 26, 2020

(54) NON-TRANSITORY COMPUTER-READABLE MEDIUM INCLUDING A PREVIEW PRESENTATION PROGRAM, PROCESSING METHOD, AND CAM SYSTEM

(71) Applicant: DGSHAPE Corporation, Hamamatsu-shi (JP)

(72) Inventors: Makoto YOSHIDA, Hamamatsu-shi (JP); Yukie KANNO, Hamamatsu-shi (JP); Yoshimitsu ASAHINA, Hamamatsu-shi (JP)

(21) Appl. No.: 16/574,244

(22) Filed: Sep. 18, 2019

(30) Foreign Application Priority Data
Sep. 26, 2018 (JP) 2018-180227

(51) Int. Cl. G05B 19/4099; G02B 27/18

(52) U.S. Cl. CPC G05B 19/4099; G05B 2219/31048; G05B 2219/35012; G02B 27/18

(57) ABSTRACT

A non-transitory computer-readable medium includes a preview presentation program to control a visible-light source of a processor to cause the visible-light source to make a preview presentation of a contour of a desired drawing by selectively projecting a beam of visible light to a site where the contour of the desired drawing is to be drawn, before controlling the processor to cause the processor to perform a drawing processing to draw the desired drawing on a surface of a workpiece.

### CROSS REFERENCE TO RELATED APPLICATIONS

This application claims the benefit of priority to Japanese Patent Application No. 2018-180227 filed on Sep. 26, 2018. The entire contents of this application are hereby incorporated herein by reference.

### BACKGROUND OF THE INVENTION

### 1. Field of the Invention

The present invention relates to non-transitory computer-readable media each including a preview presentation program, processing methods, and CAM systems.

### 2. Description of the Related Art

Processors that process the surface of workpieces to draw drawings have been known. In such processors, a technique that involves previously presenting, on the surface, how it is going to be processed before actual processing (hereinafter, preview presentation) has also been known. Preview presentations are useful because the shape of a drawing to be processed on the surface of a workpiece and where it is going to be drawn can be grasped before actual processing.

For example, JP-A-2017-029992 discloses processors that can make full-line or outline presentations as preview presentations made in marking the surface of workpieces. In this disclosure, in the full-line presentations, a visible laser beam is projected onto the surface of a workpiece along paths that are identical to processing paths of marking and a preview presentation of the result of the marking is made. In the outline presentations, a visible laser beam is projected onto the surface of a workpiece along a contour of a rectangular area that includes an area in which what is processed is drawn and a preview presentation of the result of the marking is made.

The above-mentioned full-line presentations, however, have a problem that a longer processing path requires a longer period of time for its preview presentation. In particular, it takes a long period of time to make a preview presentation when the processing path includes a path along the contour of the drawing and one or more paths for filling the drawing inside the contour.

### SUMMARY OF THE INVENTION

Preferred embodiments of the present invention provide non-transitory computer readable media including programs with which preview presentations are able to be made in a short period of time, processing methods performed by the programs, and CAM systems that generate data used in executing the programs.

According to a preferred embodiment of the present invention, a non-transitory computer readable medium includes a preview presentation program that controls a visible-light source of a processor to cause the visible-light source to make a preview presentation of a contour of a desired drawing by selectively projecting a beam of visible light to a site where the contour of the desired drawing is to be drawn, before controlling the processor to cause the processor to perform a drawing processing for drawing the desired drawing on a surface of a workpiece.

According to a preferred embodiment of the present invention, preview presentations are able to be made in a short period of time.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a schematic diagram illustrating a processing system, a CAD system, and a CAM system according to preferred embodiments of the present invention.

FIG. 2 is a diagram for explaining drawing information according to a preferred embodiment of the present invention.

FIG. 3 is a diagram for explaining an example of a drawing-creation window according to a preferred embodiment of the present invention.

FIG. 4 is a diagram for explaining processing paths according to a preferred embodiment of the present invention.

FIG. 5 is a diagram for explaining contour paths according to a preferred embodiment of the present invention.

FIG. 6 is a flowchart for explaining a processing method according to a preferred embodiment of the present invention.

FIG. 7 is a diagram for explaining a presentation step according to a preferred embodiment of the present invention.

FIG. 8 is a diagram for explaining a representation step according to a preferred embodiment of the present invention.

### DETAILED DESCRIPTION OF THE PREFERRED EMBODIMENTS

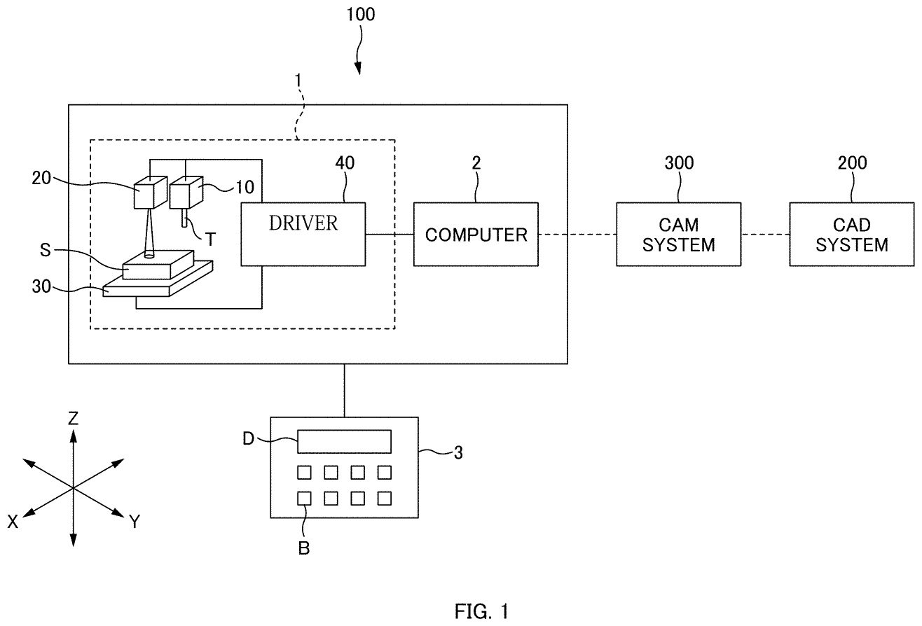

FIG. 1 is a diagram showing a processing system 100, a CAD system 200, and a CAM system 300. A processing method according to this preferred embodiment can be performed by the processing system 100.

The CAD system 200 is usable to generate drawing data. Each drawing data represents a desired drawing that is drawn on a surface of a workpiece S. Examples of the desired drawing include a character, a drawing, a symbol and so on or any combination of two or more of them.

The CAD system 200 includes a display, and an input interface such as a keyboard or a mouse. Users are allowed to create and edit a desired drawing by, for example, operating a keyboard or a mouse via a drawing-creation window presented on a display. The CAD system 200 generates a drawing data based on the desired drawing that has been created and edited via the drawing-creation window.

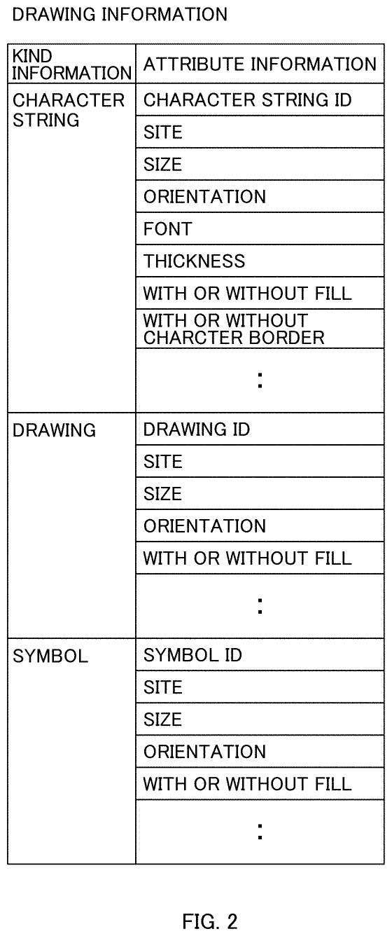

The drawing data includes drawing information. The drawing information is set for each of the drawings included in the desired drawing. As shown in FIG. 2, each drawing information includes kind information and attribute information. The kind information and attribute information are associated with each other. The kind information is, for example, a character string, a drawing, a symbol or the like.

When the kind information is a character string, information representing, for example, “character string ID,” “site where the character string is drawn,” “size,” “orientation,” “font,” “thickness of each character,” “with or without fill,” and “with or without a character frame” belong to the attribute information associated with that kind information. The character string ID is an identifier to specify a character string that should be drawn. The character string ID may be a character string which is the same as the character string that should be drawn.

When the kind information is a drawing, information representing, for example, “drawing ID,” “site where the drawing is drawn,” “size,” “orientation,” and “with or without fill” belong to the attribute information associated with that kind information. The drawing ID is an identifier to specify a drawing that should be drawn. For example, the drawing ID is an identifier to specify a drawing such as a circle, a triangle, or a star-shape.

When the kind information is a symbol, information representing, for example, “symbol ID,” “site where the symbol is drawn,” “size,” “orientation,” and “with or without fill” belong to the attribute information associated with that kind information. The symbol ID is an identifier to specify a symbol that should be drawn. For example, the symbol ID is an identifier to specify a symbol such as an arrow, a music note symbol, or a postal mark.

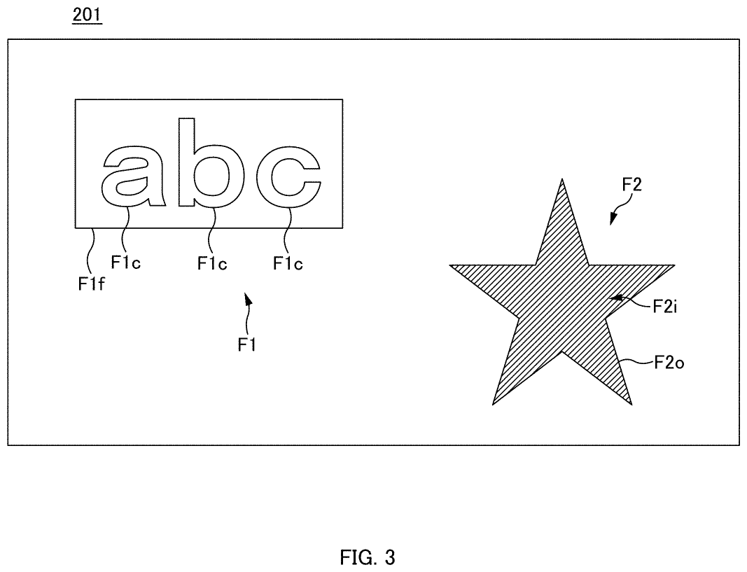

FIG. 3 shows an example of drawings that have been created and edited via a drawing-creation window 201. In this example, two drawings (a character F1 and a drawing F2) are shown.

The character F1 is a character string which is a sequence of alphabets “abc” of which kind information is “character string.” The character F1 includes a character frame portion F1f and character portions F1c as shown in the drawing-creation window 201 in FIG. 3. The character portions F1c are surrounded by the character frame portion F1f. In this case, the drawing information is set such that, among those belonging to the attribute information for the character F1, the “character ID” is abc, the “orientation” is landscape, the “font” is Gothic, the “with or without fill” is “without,” and “with or without a character frame” is “with.”

The drawing F2 is a star-shaped drawing of which kind information is “drawing.” The drawing F2 is filled with diagonal hatching as shown in the drawing-creation window 201 in FIG. 3. In this case, the drawing information is set such that, among those belonging to the attribute information for the character F2, the “with or without fill” is “with.” In this case, the drawing F2 can be said to have a contour F2o and an inside part F2i surrounded by the contour F2o.

The CAD system 200 outputs the generated drawing data to the CAM system 300.

The CAM system 300 is usable to generate processing path data and contour path data.

The processing path data are usable to draw a desired drawing by processing a surface of the workpiece S in a drawing step of a processing method described later. The contour path data are usable to make a preview presentation of the contour of a desired drawing based on the processing path data in a presentation step of the processing method described later. The preview presentation is executed by selectively projecting a beam of visible light to a site where the contour of the desired drawing is to be drawn on the surface of the workpiece S, and details thereof are described later.

The “processing method” herein may be either a processing method by cutting or a processing method by laser projection. The processing path data and the contour path data according to this preferred embodiment can be applied to both of these processing methods.

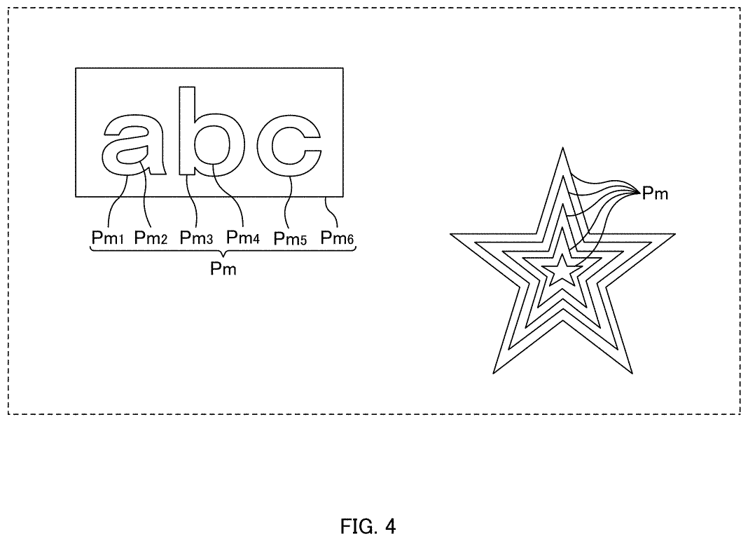

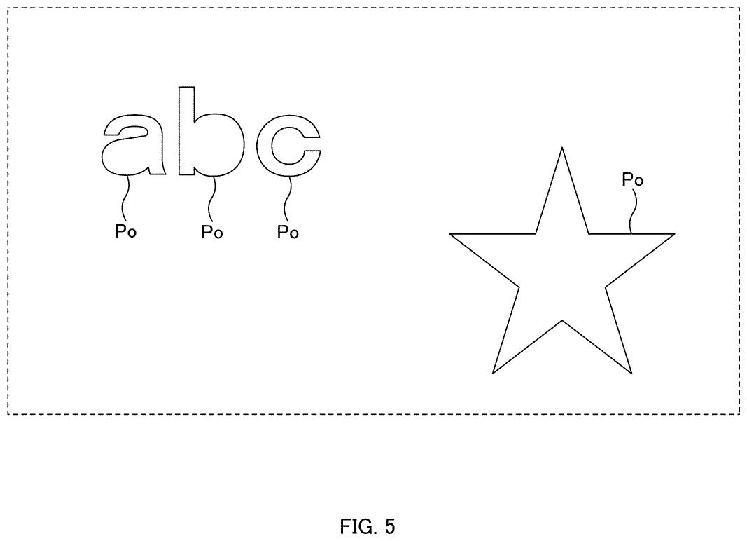

FIG. 4 is a diagram for explaining a method of generating processing path data by the CAM system 300. FIG. 5 is a diagram for explaining a method of generating contour path data by the CAM system 300. The CAM system 300 generates a processing path data and a contour path data based on a drawing data received from the CAD system 200. Each of the processing path data and the contour path data preferably includes multiple point data. Each of the point data has two-dimensional (x- and y-) coordinates. The two-dimensional (x- and y-) coordinates are located either on a processing path Pm or on a contour path Po. Therefore, to generate a processing path data and a contour path data, a processing path Pm and a contour path Po are established at the beginning. FIG. 4 illustrates processing paths Pm established for the example in FIG. 3. FIG. 5 illustrates contour paths Po established for the example in FIG. 3.

First, how the processing path Pm for the character F1, of which kind information is “character string,” is established is described. As described above, in this example, “without” is set for the “with or without fill” which is one belonging to the attribute information for the character F1. In this case, as shown in FIG. 4, the processing paths Pm are established along the curves of each character. Accordingly, two closed processing paths Pm1 and Pm2 are established for the portion “a” of the character string “abc.” The processing path Pm1 is established outside the processing path Pm2 and surrounds the processing path Pm2. In addition, two closed processing paths Pm3 and Pm4 are established for the portion “b”. The processing path Pm3 is established outside the processing path Pm4 and surrounds the processing path Pm4. Furthermore, a single closed processing path Pm5 is established for the portion “c”. In addition, a single closed processing path Pm6 is established along the character frame.

Next, how the contour path Po for the character F1 is established is described. When the “kind information” is the character string, the method of establishing the contour path Po is not limited to a single method. First and second examples of these methods are described below. In this preferred embodiment, a preferred embodiment to which the second example of the methods is applied is described.

First, the first example is described. In this case, the contour path Po is established by extracting only the outermost processing path Pm out of the all processing paths Pm1 to Pm6 that have been established above. In this case, the contour path Po is identical to the processing path Pm6 that is along the character frame out of the processing paths Pm.

Next, the second example is described. When the “with or without a character frame” that belongs to the attribute information is “with” as in the present preferred embodiment, the contour path Po may be established as follows. As shown in FIG. 5, the contour paths Po are established by extracting only the outermost processing paths Pm out of the processing paths Pm for the drawing F1 except for the one on the character frame portion F1f. That is, in this example, the contour path Po includes the processing path Pm1, the processing path Pm3, and the processing path Pm5.

Establishment of the contour path Po in this manner is advantageous when the arrangement of the character portions F1c in the character frame portion F1f of the drawing F1 can be checked with high precision on a preview presentation.

Next, how the processing path Pm for the drawing F2 of which kind information is “drawing” is established is described. As described above, in this example, “with” is set for “with or without fill” which is one belonging to the attribute information for the drawing F2. Thus, as shown in FIG. 4, as the processing path Pm, multiple closed processing paths Pm that are established one inside another are assumed as the processing path Pm. The outermost path out of the multiple closed processing paths Pm have been established along the contour of the drawing F2. The multiple closed processing paths Pm are spaced away from each other with a fixed distance between the adjacent processing paths Pm.

Next, how the contour path data for the drawing F2 is generated is described. The contour path Po is, as shown in FIG. 5, a path established by extracting the outermost path (i.e., the path along the contour of the drawing F2) out of the processing paths Pm that have been established above.

By the above-mentioned method, the processing path data and the contour path data for the drawing can be generated. The CAM system 300 outputs the processing path data and the contour path data generated using the above-mentioned method to the processing system 100.

The above-mentioned method of generating the processing path data and the contour path data is an example and preferred embodiments of the present invention are not limited thereto. As an alternative example, the processing path Pm may be established in a spiral form on the contour of and inside the drawing. In this case, the processing path Pm is established as moving closer to the center of the drawing as it revolves in one direction on the contour of the drawing and within the drawing. In this case, the contour path Po is established by extracting only the portion along the contour of the drawing from the spiral processing path Pm.

The processing system 100 draws a desired drawing on a surface of the workpiece S by cutting the surface with a processing tool T. The processing system 100 has a processor 1, a computer 2, and an operation panel 3. The processing system 100, however, may include the processor 1 and the operation panel 3 when the functions of the computer 2 are achieved by the processor 1.

The processor 1 includes a gripper 10, a visible-light source 20, a holder 30, a driver 40, and the operation panel 3. The gripper 10 grasps the processing tool T used for cutting. The visible-light source 20 projects one or more beams of visible light onto the surface of the workpiece S in preview presentations described below. As the visible-light source 20, for example, a laser pointer can be used. The holder 30 holds the workpiece S. The driver 40 relatively shifts, three-dimensionally, the positions of the holder 30 and the gripper 10 or the positions the holder 30 and the visible-light source 20.

In this preferred embodiment, although the description is made using the processor 1 by cutting as the processor 1, the processing method using the processing path data and the contour path data according to this preferred embodiment can also be performed for a processor by laser projection.

The computer 2 is supplied with the processing path data and the contour path data generated by the CAM system 300. The computer 2 controls, based on the processing path data and the contour path data, the processor 1 to cause the processor 1 to perform a presentation step and a drawing step.

In the presentation step, the computer 2 controls, based on the contour path data generated in advance by the CAM system 300, the driver 40 to relatively moves the visible-light source 20 three-dimensionally to the holder 30. As a result, the preview presentation of the contour of the desired shape is executed by selectively projecting the beam of visible light to the site where the contour of the desired drawing is to be drawn on the surface of the workpiece S.

The operation panel 3 is usable to perform various operation inputs to the processor 1. The operation panel 3 is equipped with a display D and multiple buttons. In the example shown in FIG. 1, eight buttons B are shown. The number of the buttons B is not limited thereto. In addition, in place of some of the buttons B, for example, a jog dial may be provided. In the presentation step, a user can regulate an operation speed of the visible-light source via the operation panel 3. Furthermore, in the presentation step, the user can pause, proceed, or end an operation of the visible-light source 20 via the operation panel 3. Here, the operation of the visible-light source 20 includes relative operations of the visible-light source 20 to the holder 30, outputs of visible light, or the like. That is, the user can regulate the speed at which the visible-light source 20 scans along the contour path Po and can pause, proceed, or end the scanning. Furthermore, when the output of the visible light is pulsed, the user can regulate its pulse frequency, or switch turning on and off of it.

For example, when the user presses one button B, the processor 1 causes the visible-light source 20 to start its scanning to start the presentation step. In addition, in the presentation step, when the user presses the button B, the processor 1 causes the visible-light source 20 to pause the scanning. When the user presses that one button B again, the processor 1 causes the visible-light source 20 to proceed the scanning. Furthermore, in the presentation step, when the user presses the button B, the processor 1 causes the visible-light source 20 to reduce its scanning speed and when the user presses the button B, the processor 1 causes the visible-light source 20 to increase the scanning speed. Furthermore, in the presentation step, when the user presses the button B, the processor 1 causes the visible-light source 20 to end the scanning to end the presentation step.

In the drawing step, the computer 2 controls, based on the processing path data generated in advance by the CAM system 300, the driver 40 to relatively moves the gripper 10 three-dimensionally to the holder 30. As a result, the surface of the workpiece S on the holder 30 is cut by the processing tool T grasped by the gripper 10 and the desired drawing is thus drawn on the surface.

The processing method is performed by the processing system 100. The processing method is performed by the dedicated preview presentation program and drawing program controlling the processing system 100. These programs are pre-installed on the processing system 100. Hereinafter, the description is made, assuming that the contour path data and the processing path data have been generated by the CAM system 300 and already inputted to the processing system 100.

The processing method according to this preferred embodiment includes the presentation step and the drawing step. The presentation step is for making a preview presentation of the contour of the desired drawing. The presentation step is performed by the preview presentation program controlling the processing system 100. The presentation step is performed before the drawing step. The drawing step is for drawing the desired drawing by processing the surface of the workpiece S using the processor 1.

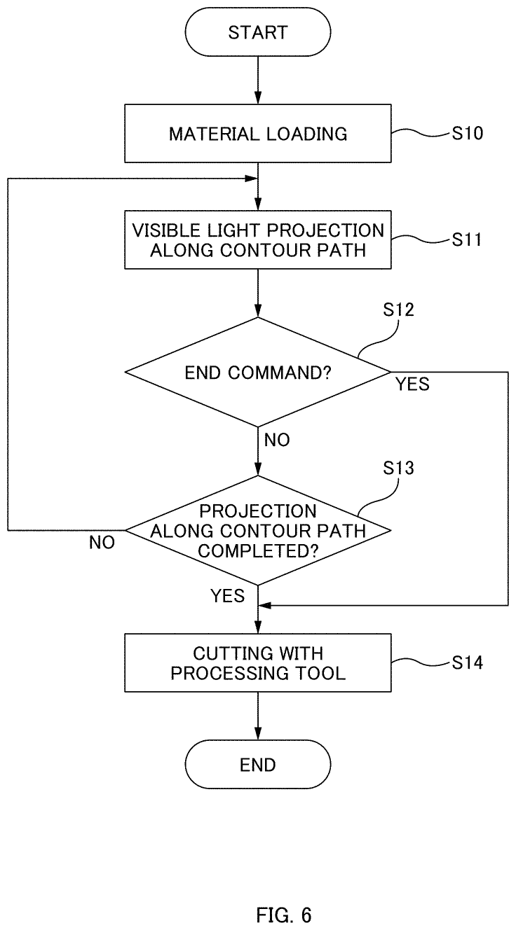

Referring to FIGS. 6 to 8, a specific example of the processing method according to this preferred embodiment is described. FIG. 6 is a flowchart for explaining the processing method according to this preferred embodiment. First, the user selects the workpiece S and loads it on the holder 30 of the processor 1 (loading of a material; step 10). Then, in the presentation step, the computer 2 executes a preview presentation.

The preview presentation is executed by selectively projecting the beam of visible light to the site where the contour of the desired drawing is to be drawn on the surface of the workpiece S using the visible-light source 20 of the processor 1. That is, in the preview presentation, the beam of visible light is projected only to the site where the contour of the desired drawing is to be drawn on the surface of the workpiece S.

In the presentation step, the computer 2 controls, based on the contour path data generated in advance by the CAM system 300, the driver 40 to relatively move the visible-light source 20 three-dimensionally to the holder 30 (projection of a beam of visible light along the contour path Po; step 11). As a result, the visible light is selectively projected to the site where the contour of the desired drawing is to be drawn on the surface of the workpiece S on the holder 30.

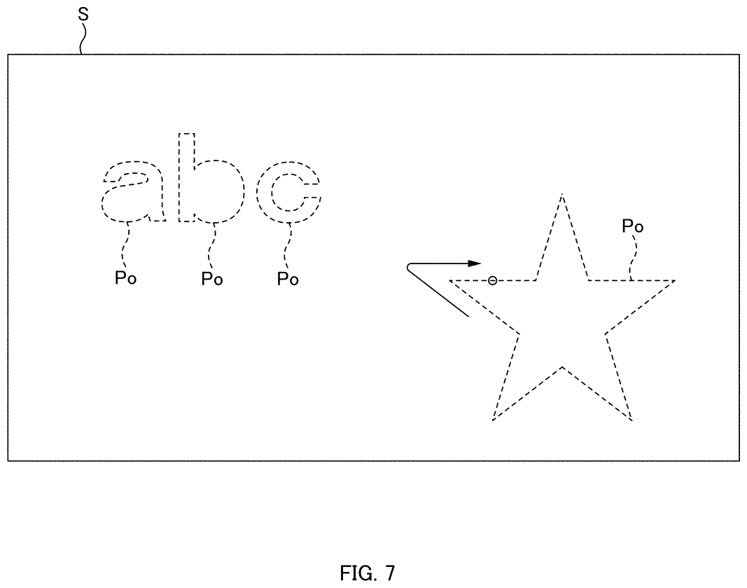

FIG. 7 is a diagram for explaining the presentation step according to this preferred embodiment. In this figure, the contour path Po is denoted by a broken line on the workpiece S. In this figure, the position at which the beam of visible light traveling along the contour path Po is projected is depicted by a white circle.

When the projection of the beam of visible light along the entire contour path Po has been completed (step 13: Y), the computer 2 causes the preview presentation to be ended and the presentation step is ended.

During the preview presentation, the user visually observes the position at which the beam of visible light traveling along the contour path Po is projected. With this, the user can preview the result of processing. In particular, the user can check whether the desired drawing is going to be drawn at a desired site on the surface of the workpiece S.

When the user gives a command to end the operation of the visible-light source 20 to the computer 2 via the operation panel 3, the computer 2 causes the preview presentation to be ended and the presentation step is ended (step 12: Y).

After the presentation step is ended and the user judges, from the contour of the desired drawing of which preview presentation has been made, that no error can be found in the processing result, the operation proceeds to the drawing step. In the drawing step, the computer 2 controls, based on the processing path data generated in advance by the CAM system 300, the driver 40 to relatively move the gripper 10 three-dimensionally to the holder 30. As a result, the surface of the workpiece S on the holder 30 is cut by the processing tool T grasped by the gripper 10 and the desired drawing is drawn on that surface (cutting with the processing tool T; step 14).

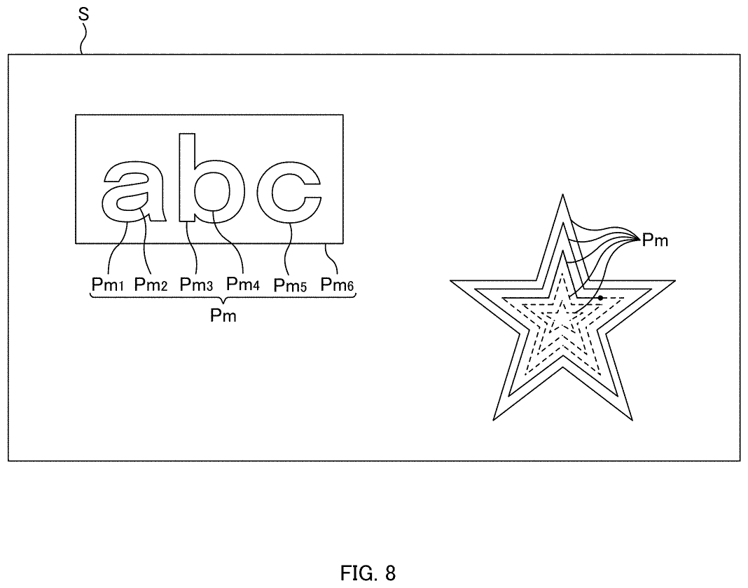

FIG. 8 is a diagram for explaining the drawing step according to this preferred embodiment. In this figure, the processing path Pm is shown on the workpiece S. Among the processing paths Pm, the portions that have been processed by the processing tool T are depicted by solid lines and that have not been processed are depicted by broken lines.

When the processing of all processing paths Pm has been made, the computer 2 causes the drawing step to be ended. The processing using the processing method according to this preferred embodiment is ended through the steps mentioned above.

As described above, the preview presentation program according to this preferred embodiment controls the visible-light source of the processor 1 to cause the visible-light source to make a preview presentation of the contour of the desired drawing by selectively projecting a beam of visible light to the site where the contour of the desired drawing is to be drawn, before controlling the processor 1 to cause the processor to perform a drawing processing for drawing the desired drawing on the surface of the workpiece S.

By causing the processor 1 to execute such preview presentation program, the time required for a preview presentation is not prolonged because it is unnecessary for the processor 1 to make a preview presentation of the entirety of the desired drawing. That is, by using the preview presentation program according to this preferred embodiment, preview presentations are able to be made in a short period of time. In this case, the beam of visible light is selectively projected to the site where the contour of the desired drawing is to be drawn, the precision of the preview presentation is not reduced in terms of, for example, the site, the size, and the range of the desired drawing is to be drawn.

Furthermore, in the preview presentation program according to this preferred embodiment, the desired drawing includes the contour and an inside portion surrounded by the contour. That is, the time for making a preview presentation is able to be reduced because it is unnecessary for the processor 1 to make any preview presentations of the processing result for the inside portion.

Furthermore, in the preview presentation program according to this preferred embodiment, the operation speed of the visible-light source 20 is able to be regulated. Thus, the operation speed is able to be reduced for portions of which preview presentation should be made with high precision, and the operation speed can be increased for other portions. With this, it is possible to make preview presentations at a higher efficiency with a higher precision.

In addition, in the preview presentation program according to this preferred embodiment, the operation of the visible-light source 20 is able to be paused, continued, or ended. That is, for a portion of which preview presentation should be made carefully, the preview presentation is able to be made while repeating a pause or a proceeding. Moreover, if the user judges, midway through the course of a preview presentation, that it is unnecessary to continue the preview presentation more, the preview presentation can be ended at that point. As a result, it is possible to make preview presentations at a higher efficiency with a higher precision.

The processing method according to this preferred embodiment includes, before the drawing step, the presentation step of making a preview presentation of the contour of the desired drawing by selectively projecting a beam of visible light to the site where the contour of the desired drawing is to be drawn, using the visible-light source 20 of the processor 1.

The time required for a preview presentation is not prolonged because it is unnecessary for the processor 1 to make a preview presentation of the entire portion of the desired drawing. In this case, the beam of visible light is selectively projected to the site where the contour of the desired drawing is to be drawn, the precision of the preview presentation is not reduced in terms of, for example, the site, the size, and the range of the desired drawing is to be drawn.

Furthermore, as described above, the CAM system 300 according to this preferred embodiment generates the processing path data usable to draw the desired drawing by processing the surface of the workpiece S and the contour path data usable to make a preview presentation of the result of the processing based on the processing path data by selectively projecting a beam of visible light to the site where the contour of the desired drawing is to be drawn.

By using the contour path data in making a preview presentation in the processing by the processing system 100, the time required for a preview presentation is not prolonged because it is unnecessary to make a preview presentation of the entire portion of the desired drawing. In this case, the beam of visible light is selectively projected to the site where the contour of the desired drawing is to be drawn, the precision of the preview presentation is not reduced in terms of, for example, the site, the size, and the range of the desired drawing is to be drawn.

It is also possible to supply a program to a computer using a non-transitory computer readable medium with an executable program thereon, in which the processing program of the above-mentioned preferred embodiment is stored. Examples of the non-transitory computer readable medium include magnetic storage media (e.g. flexible disks, magnetic tapes, and hard disk drives), and CD-ROMs (read only memories).

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A non-transitory computer-readable medium including a preview presentation program that is executable to control a visible-light source of a processor to cause the visible-light source to make a preview presentation of a contour of a desired drawing by selectively projecting a beam of visible light to a site where the contour of the desired drawing is to be drawn, before controlling the processor to cause the processor to perform a drawing processing to draw the desired drawing on a surface of a workpiece.

2. The non-transitory computer-readable medium according to claim 1, wherein the desired drawing includes the contour and an inside surrounded by the contour.

3. The non-transitory computer-readable medium according to claim 1, wherein an operation speed of the visible-light source is capable of being regulated.

4. The non-transitory computer-readable medium according to claim 1, wherein an operation of the visible-light source is capable of being paused, proceeded, or ended.

5. A processing method comprising:
before a drawing step,
a presentation step of making a preview presentation of a contour of a desired drawing by selectively projecting a beam of visible light to a site where the contour of the desired drawing is to be drawn, using a visible-light source of a processor.

6. A CAM system that generates:
a processing path data usable to draw a desired drawing by processing a surface of a workpiece; and
a contour path data usable to make a preview presentation of a result of a processing based on the processing path data by selectively projecting a beam of visible light to a site where a contour of the desired drawing is to be drawn.
